(19) United States
(12) Patent Application Publication
(10) Pub. No.: US 2009/0070191 A1
(43) Pub. Date: Mar. 12, 2009

(54) POSTAGE OPTIMIZATION FOR BULK MAILINGS

(76) Inventor: Robert G. Gaito, Troy, NY (US)

Correspondence Address: HOFFMAN WARNICK LLC, 75 STATE STREET, 14TH FLOOR, ALBANY, NY, 12207, US

(21) Appl. No.: 11/854,173

(22) Filed: Sep. 12, 2007

(51) Int. Cl. G06F 17/30

(52) U.S. Cl. 705/10

(57) ABSTRACT

A system, method and program product for optimizing a mailing list. A system is provided that includes a system for determining a postage tier for each name in a mailing list; a system for adding names to the mailing list to complete bundles required to qualify for postage discounts at each of a plurality of different postal tiers; and a system for calculating a return on investment, wherein the system for calculating the return on investment projects whether a set of added names for a bundle will result in a positive return on investment.

### FIELD OF THE INVENTION

This disclosure relates generally to processing mailing lists for bulk mailings, and more particularly relates to a system and method of optimizing mailing lists based on postage tiers and projected return on investment.

### BACKGROUND OF THE INVENTION

Due to today's highly competitive marketplace, large amounts of money must typically be spent by direct marketers on promotions to generate sales. This is particularly the case for catalog driven businesses in which the cost of producing and mailing catalogs is substantial. Accordingly, understanding the likely return for a catalog mailing sent to a particular mailing list allows direct marketers to more effectively utilize their marketing resources for a marketing campaign.

Generally, most catalog/retail marketers create a finite amount of groups (often referred to as lists) for each respective mailing. Lists are generally separated into two groups: buyers and non-buyers. Each of these lists contains a large number of names that have homogeneous characteristics by nature within the list. For example, across a buyer universe, marketers may create lists based upon RFM (Recency, i.e., time since last purchase, Frequency of purchases, Monetary, i.e., amount of purchases), or based upon a score of a statistical model. Across the non-buyer universe, lists are created based on source of name (e.g., where is list rented from) or based on recent contact (e.g., names of individuals who have made inquiries). There are other methods for developing lists but these are the most common in the direct marketing industry.

The concept of “projected sales per book” (PSPB) provides a commonly used metric in the industry for rating or ranking lists. Marketers assign a PSPB value to a list based upon the actual performance of each list in a prior mailing (or a series of prior mailings). This actual performance is generally projected to the whole list (as if all of the names have been mailed in it) and is therefore is a measurement indicating how much each name mailed will spend (on average) within that list.

For example, a first list LIST_A of 100,000 households may have a PSPB of $0.95, while a second list LIST_B of 200,000 households may have a PSPB of $0.80. Thus, the assumption is that for each catalog sent, the company, on average, will receive $0.95 in revenue from households in LIST_A and $0.85 in revenue from households in LIST_B.

Armed with the PSPB and the costs associated with producing and mailing each book, marketers can project whether a given mailing will be profitable. However, given the current structure of postal rate tiers, significant complications arise in calculating costs. The US Postal Service (USPS) currently provides nine different cost tiers that are applied to mailings, and rates can vary from about $0.25 to over $0.50 per piece. Rates depend on, e.g., whether a minimum bundle size is being mailed to a common carrier route, a common zip code, whether the four digit zip code extension (Zip4) is included, etc. Given the fact that a mailing might include hundreds of thousands or even millions of pieces, current techniques typically assume some average mailing cost for each catalog.

Unfortunately, this approach provides a great deal of uncertainty with respect to profitability at the name or per-catalog level, and may result in many “unprofitable” catalogs being mailed. Moreover, because per-catalog costs are not known, it is impossible to optimize the mailing list by, e.g., adding names to increase postal rate efficiencies, or removing individual names that are not likely to result in profit. Accordingly, a need exists for a process that can more effectively analyze the impact of postal rate tiers on bulk mailings.

### SUMMARY OF THE INVENTION

The present invention relates to a system, method and program product for processing mailing lists to maximize return on investment (ROI). More particularly, disclosed are various techniques for analyzing postage costs and minimizing their impact on the overall profitability of bulk mailings.

In a first embodiment, there is a mailing list processing system, comprising: a system for determining a postage tier for each name in a mailing list; a system for adding names to the mailing list to complete bundles required to qualify for postage discounts at each of a plurality of different postal tiers; and a system for calculating a return on investment, wherein the system for calculating the return on investment projects whether a set of added names for a bundle will result in a positive return on investment.

In a second embodiment, there is a program product stored on a computer readable medium, which when executed by a computer system processes a mailing list, and comprises: program code for determining a postage tier for each name in the mailing list; program code for adding names to the mailing list to complete bundles required to qualify for postage discounts at a higher postal tier; and program code for calculating a return on investment, wherein the return on investment projects whether a set of added names for a bundle will result in a positive return on investment.

In a third embodiment, there is a method of processes a mailing list, comprising: determining a postage tier for each name in the mailing list; adding names to the mailing list to complete bundles required to qualify for postage discounts at a higher postal tier, including calculating a return on investment to project whether a set of added names for a bundle will result in a positive return on investment; identifying names in the mailing list that are projected to result in a negative return on investment; and outputting an optimized mailing list.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having mailing list processing system in accordance with an embodiment of the present invention.

FIG. 2 depicts a postage tier chart.

FIG. 3 depicts a hole filling example in accordance with an embodiment of the present invention.

FIG. 4 depicts a table showing the effects of filling holes in accordance with an embodiment of the present invention.

FIG. 5 depicts an analysis output in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

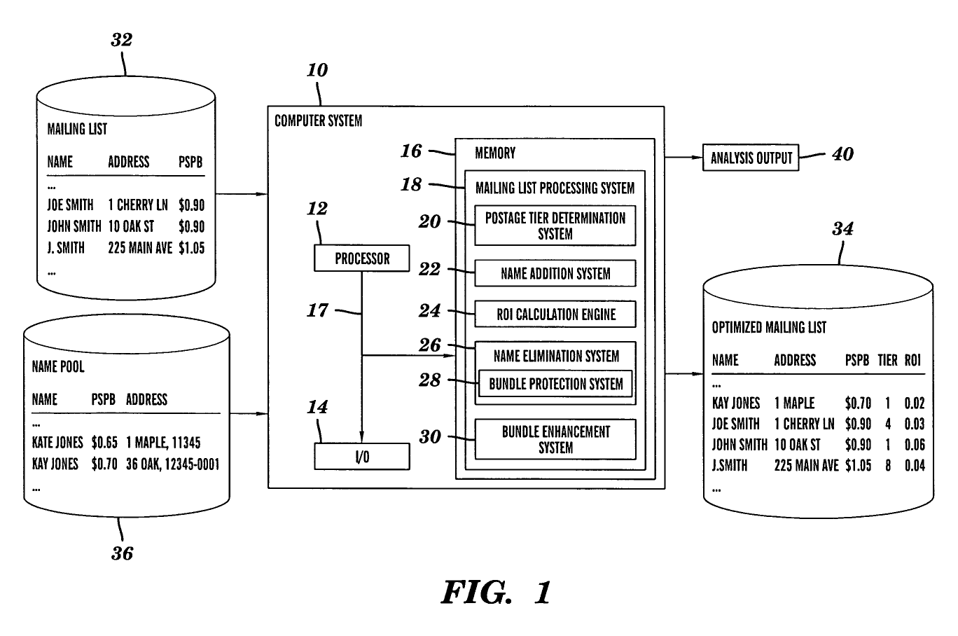

Referring to the drawings, FIG. 1 depicts a computer system 10 having a mailing list processing system 18 for processing mailing list 32 and generating an optimized mailing list 34. Mailing lists 32, 34 may be embodied in any format, e.g., a file, a database, as a data object, etc., and generally include entries (i.e., names and addresses) targeted to receive a mailing, such as a catalog. Furthermore, initial mailing list 32 may comprise a set of smaller lists combined together to form a master list. Mailing list processing system 18 optimizes mailing list 32 by factoring in the impact of postal tiers to identify opportunities to add or eliminate names to maximize projected return on investment. As noted, mailing lists 32, 34 may be provided in any format and include any information along with each name, including, e.g., a projected sales per book (PSPB), a PIN number, etc.

Mailing list processing system 18 includes: (1) a postage tier determination system 20 that determines what postage tier each name in the mailing list 32 falls into; a name addition system 22 that can add names to mailing list 32 from a name pool 36 to achieve minimum bundle sizes necessary to qualify for discounted postage tiers; a return on investment (ROI) calculation engine 24 that can calculate breakeven/profitability results at the individual name level; a name elimination system 26 for identifying and/or eliminating unprofitable names from the mailing list 32; and a bundle enhancement system 30 for adding additional names from the name pool 36 that qualify for top postage tiers. In addition, mailing list processing system 18 may generate an analysis output 40 that allows the end user to view the proposed optimizations, and make determinations regarding their implementation.

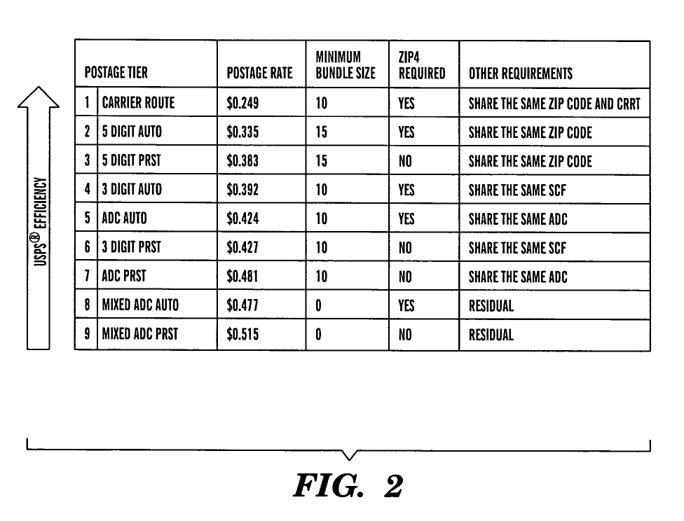

As noted, the USPS® breaks postage rates for each class of mail into a series of tiers, which is shown in FIG. 2. The purpose behind this approach is to provide incentives to mailers to prepare their mail in such a way that it is efficient for the USPS® to handle. The most efficient mail will be classified in the highest tier and, as such, receives a substantial postage discount. For example, the highest tier (tier 1, Carrier Route or CRRT) has a current postage rate of $0.249 but requires a Zip4, a common zip code, and a minimum bundle size of 10 pieces to be delivered along the same carrier route. Mail pieces that are less efficient for the USPS® to handle will be categorized in lower tiers and will be more expensive to mail. As can be seen, the top seven tiers have a minimum bundle size. As such, meeting minimum bundle sizes can create significant postage savings.

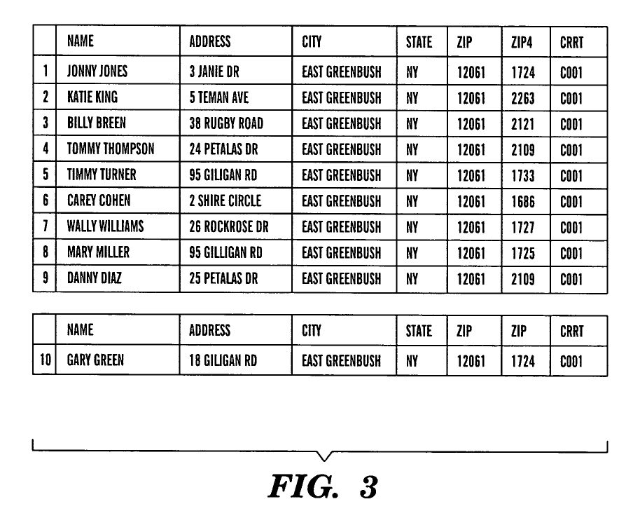

One method of meeting minimum bundle requirements is to employ a technique referred to as “Add-A-Name,” in which a set of (i.e., one or more) names are added to the mailing with the sole purpose of attaining minimum bundle requirements. For example, assume that there is one particular carrier route within a Zip Code that is only slated to receive nine pieces of mail, as shown in the top portion of FIG. 3. Since 10 pieces of mail are need to make a bundle that qualifies at the CRRT tier (and receive the most attractive postage rate), name addition system 22 can be employed to pull a name in that carrier route from name pool 36 to complete the bundle. Name pool 36 may be obtained from any source available to the mailing entity, e.g., it may comprise one or more lists of lower performing names owned by the mailing entity, it may comprise names that are available for purchase by a service provider, etc.

In the above example, with nine pieces going to the carrier route in question, there are substantial postage savings to be obtained by filling the available “hole”. If a qualifying name (such as that shown in bottom of FIG. 3) was added to the mailing list 34, all 10 pieces would get the CRRT tier postage rate. Assume that before filling the hole, postage for the nine pieces would have been applied at the 5 Digit Automation Tier (tier 2), at a cost of:

9 pieces*$0.335=$3.01.

After filling the hole, postage for 10 pieces at the CRRT Tier (tier 1) would be:

10 pieces*$0.249=$2.49,

which would result in a savings of $0.52. Thus, from a postage point of view, it is actually less expensive to mail 10 pieces at the CRRT Tier than it is to mail nine pieces at the 5 Digit Automation Tier.

Referring again To Whom It May Concern: FIG. 1, before employing name addition system 22, it is required that a postage tier be known for each name in the mailing list 32. Because postage tiers are dependent upon the specific set of names provide in the mailing list 32, which may be somewhat fluid, a postage tier determination system 20 is provided to process the mailing list 32 and determine which tier each entry falls into (as shown in optimized mailing list 34). This process generally involves examining the address information associated with each name, and identifying the highest tier the name qualifies for in light of all the names in the mailing list 32.

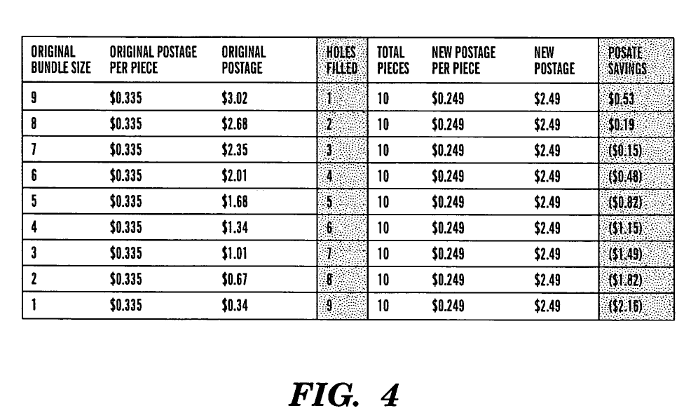

Once postage tiers are determined for each name, name addition system 22 scans the optimized mailing list 34 to identify opportunities to fill holes at different tier levels, and utilizes ROI calculation engine 24 to determine if it is worthwhile filling holes in each case. It is important to note that the more holes required to be filled for a given bundle, the lower the postage savings. An example of this is shown in the table depicted in FIG. 4. The table depicts potential postage savings associated with filling holes at the CRRT tier. As can be seen, filling three or more holes actually results in an increase in postage. Accordingly, name addition system 22 may initially look for bundles that need just one or two holes filled.

In determining return on investment, ROI calculation engine 24 must factor in any additional costs, such as the paper and printing costs associated with each name added to the mailing list 34. As noted above ROI calculation engine 34 can calculate an ROI at the name level. To illustrate this point, the table in FIG. 4 shows the impact of filing two holes within the CRRT Tier. Postage for the original eight pieces in the 5 Digit Automation Tier (tier 2) would be:

8 pieces*$0.335=$2.680.

Postage for eight pieces at the CRRT Tier (tier 1) would be:

8 pieces*$0.249=$1.992, plus postage for two new pieces required to complete the CRRT bundle:

2 pieces*$0.249=$0.498, resulting in a total postage of $2.490.

At first glance, it appears that costs are reduced by mailing more names. The reality, however, is that only the postage costs are reduced. Assuming, e.g., that it will cost approximately $0.30 to produce each additional mail piece, the overall costs actually rise and thus the financial viability of adding these names must first be analyzed by ROI calculation engine 24.

Accordingly, before filling holes, ROI calculation engine 24 must be employed to determine the efficacy of filling holes in different bundles. An illustrative process is as follows. The postage savings associated with filling two holes (calculated above) is $0.19. The production costs required to print two additional pieces is: 2 pieces*$0.30=$0.60, which results in a total extra cost of $0.41. Before making a final decision regarding the number of holes to fill, there is one last factor to be considered, namely, the incremental contribution that the additional names will generate. Incremental contribution is based on the projected sales per book (PSPB) associated with the name. In the above case, the two additional names must be projected to generate more than $0.41 in incremental contribution in order for the addition of the two names to be considered a positive return on investment.

The bottom line is that the stronger the names are (i.e., the higher the PSPB), the more holes that can be filled. Often, names available from name pool 36 comprise older “housefile” names that are relatively strong but not quite strong enough to mail on their own. Name addition system 22 operates on the premise that the postage savings provided by filling holes may offset their marginal performance and that are projected to have a positive return on investment.

Carrying the above example through to the end, assume that the two additional mail pieces will generate a $0.25 contribution each (i.e., PSPB-costs), or a total contribution of $0.50 for the bundle. Accordingly, the result of adding the two pieces to the bundle will generate a net ROI of $0.09, i.e., $0.50-$0.41. Thus, by factoring in all cost data and additional contribution attributable to the piece of mail, ROI calculation engine 24 can determine whether it is desirable to fill one or more holes to meet a minimum bundle size to qualify for a reduced postage. To fully optimize the mailing list 34, name addition system 22 and ROI calculation engine 24 can perform this evaluation on some or all postage tiers requiring a minimum bundle size.

Note that despite the efforts of name addition system 22 and ROI calculation engine 24 to qualify names in the tiers with the lowest postage, there may still be some names from the original mailing list 32 that fall into more costly tiers. In some cases the postage penalties incurred can be so great that they offset any potential contribution expected. This is especially true for names that are anticipated to be marginal performers to begin with. To address these situations, name elimination system 26 is provided to examine all of the names in the lower, more expensive tiers (e.g., tiers 7-9), and utilize ROI calculation engine 24 to calculate an ROI and evaluate whether or not they are still worth mailing.

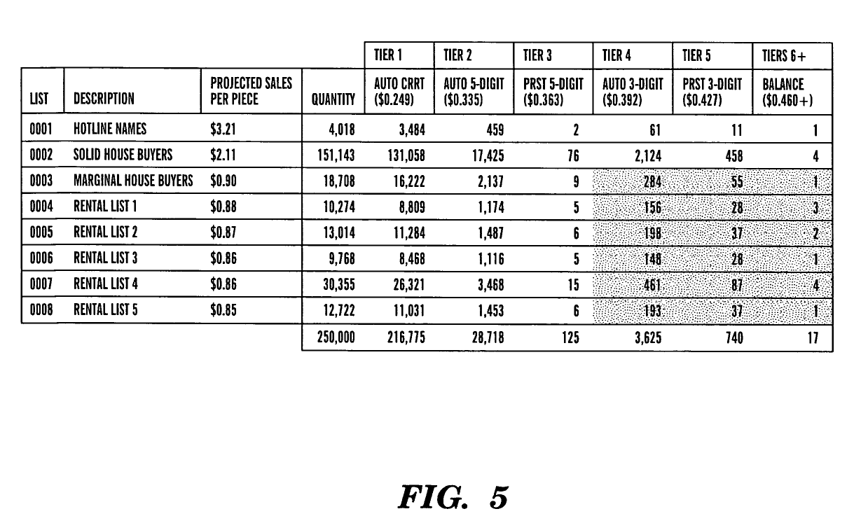

For example, FIG. 5 depicts a chart for a sample mailing list 34 consisting of 250,000 names, which is made up of eight smaller lists (e.g., Hotline names, Solid house buyers, etc.). Initially, all of the lists are projected to perform above break even. However, when the postage costs associated with names that fall in the lower ranking tiers are examined, names can be identified by ROI calculation engine 24 that fall below breakeven—i.e., have a negative ROI. Name elimination system 26 can then be employed to identify and/or drop names from the mailing list 32 that are unprofitable.

In the table shown in FIG. 5, there are 284 names from list 0003 that fall into Tier 4. When compared to the postage cost associated with Tier 1 names, these names carry with them a postage penalty of $0.14 per piece ($0.392-$0.249). Assume a projected sales per book of $0.90 for names in list 3, and a breakeven of $0.80 at the tier one level, resulting in a contribution of $0.10. However, after factoring in the $0.14 postage penalty, each book will result in a $0.04 loss. The illustrative calculation below shows that the increased postage costs causes these 284 names to fall below breakeven. In the end analysis, because this group of names will actually produce a per piece loss of $0.04, they should be considered for removal from the mail stream. Accordingly, name elimination system 28 will automatically identify these names as ones that should be dropped.

However, as part of the name elimination process, a bundle protection system 30 is employed to identify any names that, if removed, would break up a bundle and result in other names being dropped to a lower postage tier. For example, an unprofitable name belonging to a bundle of 10 names may be required to qualify the entire bundle for tier 1. Eliminating the name would disqualify each of the other nine names from the tier. Accordingly, bundle protection system 30 ensures that no such names are considered for elimination by name elimination system 28.

As a final step in the process, bundle enhancement system 32 may be employed to identify additional names from name pool 36 to add to the optimized mailing list 34. In this case, the names are not being added to fill holes, but instead are identified as names that qualify for low postage rates and may therefore have a positive ROI. In particular, marginally performing names from name pool 36 may be able to be added to tier 1 bundles which would have the effect of offsetting their lower performance with a reduced postage rate. In cases where the reduced postage rate results in a positive ROI, the names could be added without penalty.

Referring again to FIG. 1, it is understood that computer system 10 may be implemented as any type of computing infrastructure. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising a mailing list processing system 18 could be created, maintained and/or deployed by a service provider that offers the functions described herein for customers. That is, a service provider could offer to deploy or provide mail processing services as described above.

It is understood that in addition to being implemented as a system and method, the features may be provided as a program product stored on a computer-readable medium, which when executed, enables computer system 10 to provide a mailing list processing system 18. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A mailing list processing system, comprising:
a system for determining a postage tier for each name in a mailing list;
a system for adding names to the mailing list to complete bundles required to qualify for postage discounts at each of a plurality of different postal tiers; and
a system for calculating a return on investment, wherein the system for calculating the return on investment projects whether a set of added names for a bundle will result in a positive return on investment.

2. The mailing list processing system of claim 1, wherein the system for calculating the return on investment examines a projected contribution for a mailing sent to each added name, a cost associated with preparing the mailing, and a postage amount.

3. The mailing list processing system of claim 1, further comprising a name elimination system for identifying names in the mailing list that are projected to result in a negative return on investment.

4. The mailing list processing system of claim 3, wherein the name elimination system includes a bundle protection system that determines whether a name being considered for elimination will break up a bundle.

5. The mailing list processing system of claim 1, further comprising a bundle enhancement system that identifies additional names from a name pool that can be added to the mailing list to qualify for a discounted postage tier and result in a positive return on investment.

6. The mailing list processing system of claim 1, further comprising a system for outputting an optimized mailing list.

7. The mailing list processing system of claim 1, wherein the mailing list comprises a list of names to receive a catalog.

8. A program product stored on a computer readable medium, which when executed by a computer system processes a mailing list, and comprises:
program code for determining a postage tier for each name in the mailing list;
program code for adding names to the mailing list to complete bundles required to qualify for postage discounts at a higher postal tier; and
program code for calculating a return on investment, wherein the return on investment projects whether a set of added names for a bundle will result in a positive return on investment.

9. The program product of claim 8, wherein calculating the return on investment examines a projected contribution for a mailing sent to each added name, a cost associated with preparing the mailing, and a postage amount.

10. The program product of claim 8, further comprising program code for identifying names in the mailing list that are projected to result in a negative return on investment.

11. The program product of claim 10, further comprising program code for determining whether a name being considered for elimination will break up a bundle.

12. The program product of claim 8, further comprising program code for identifying additional names from a name pool that can be added to the mailing list to qualify for a discounted postage tier and result in a positive return on investment.

13. The program product of claim 8, further comprising program code for outputting an optimized mailing list.

14. The program product of claim 8, wherein the mailing list comprises a list of names to receive a catalog.

15. A method of processes a mailing list, comprising:
determining a postage tier for each name in the mailing list;
adding names to the mailing list to complete bundles required to qualify for postage discounts at a higher postal tier, including calculating a return on investment to project whether a set of added names for a bundle will result in a positive return on investment;
identifying names in the mailing list that are projected to result in a negative return on investment; and
outputting an optimized mailing list.

16. The method of claim 15, wherein calculating the return on investment examines a projected contribution for a mailing sent to each added name, a cost associated with preparing the mailing, and a postage amount.

17. The method of claim 15, further comprising determining whether a name projected to result in a negative return on investment will break up a bundle.

18. The method of claim 15, further comprising program code for identifying additional names from a name pool that can be added to the mailing list to qualify for a discounted postage tier and result in a positive return on investment.

19. The method of claim 15, wherein each added name is obtained from a pool of names initially identify as too low a performer to be included in the mailing list. further comprising program code for outputting an optimized mailing list.

20. The method of claim 15, wherein the mailing list is processed over a computer network by a service provider.
